(19) United States
(12) Patent Application Publication
(10) Pub. No.: US 2011/0175707 A1
(43) Pub. Date: Jul. 21, 2011

(54) IDENTIFICATION CARD APPARATUS

(75) Inventors: Hung-Yuan Chen, Taoyuan City (TW); Hsiung-I Hwang, Banqiao City (TW); Kuo-Peng Lu, Tucheng City (TW)

(73) Assignees: Michael H. Wade, Helotes, TX (US); Chao Ter Tseng, San Antonio, TX (US); WADE/GARCIA AND ASSOCIATES, INC., Helotes, TX (US)

(21) Appl. No.: 12/696,692

(22) Filed: Jan. 29, 2010

(30) Foreign Application Priority Data
Jan. 15, 2010 (TW) 99200854

(51) Int. Cl. H04Q 5/22

(52) U.S. Cl. 340/10.1

(57) ABSTRACT

An identification card apparatus is provided. The identification card apparatus includes a main body formed by a first housing member and a second housing member and an active radio frequency identification module which includes a battery unit having at least one coin cell, an integrated circuit board and a plurality of conductive connecting pieces. One end of the conductive connecting piece connects to a side of the coin cell, and the other end of the conductive connecting piece connects to a surface of the integrated circuit board, thereby forming a bending portion for the conductive connecting piece. Consequently, by improving the structural design of internal elements and their connection relationship, the identification card apparatus can extend the transmission range, reduce the overall dimension in thickness and weight, enhance the connection relationship of the internal elements, and increase vibration resistance, thereby improving convenience of use.

### BACKGROUND OF THE INVENTION

1. Field of the Invention

The present invention relates to an identification card apparatus, in particular, to a slim and anti-vibration active type identification card apparatus.

2. Description of Related Art

As the radio frequency identification (RFID) chip technology advances and the manufacturing cost decreases, the radio frequency identification technology is applied widely. Generally speaking, a radio frequency identification system contains a reader and a RFID tag basically, wherein the RFID tag is composed of a radio frequency identification integrated circuit and an antenna. The RFID tags can also be classified into two types, one is an active type, which contains a power source and can transmit signals; and the other one is a passive type, which has no power source and requires an external power source.

A passive RFID tags can receive a scanning signal emitted from the RFID reader. The electrical energy contained in the scanning signal is used to provoke the passive RFID tags and is capable of providing necessary electrical power for the internal circuit of tags in use. As such, the passive RFID tags don't require a built-in battery for providing electrical power, so that the overall dimensions thereof are not restricted by the volume of the built-in battery. In general, the passive RFID tags have characteristics such as slim in volume, lower cost, and higher reliability. Yet, due to the restrictions of the present wireless communication technology implemented between the antenna and the external devices (reader), the transmission range between the antenna and the reader is short. Users need to put the passive RFID tag extremely close to the reader for detecting, thereby increasing inconvenience of use.

An active RFID tag, which contains power source, can transmit signals automatically for detecting by a reader. The transmission range between the antenna and the reader of the active RFID tag is relatively wider than the passive RFID tag. As such, the active RFID tag is not required to be located nearby the reader to achieve wireless communication and information transmission. However, the overall dimensions and weight of the active RFID tag are restricted by the dimensions and weight of the built-in battery. Subsequently, the overall dimensions of the active RFID tag are heavy and large, thereby decreasing portability for ease and convenience of movement.

Except of the above-mentioned issues, the active RFID tag is designed to have more elements than the passive RFID tag. Therefore, the active RFID tag has lower reliability and might become a short circuit due to operations improperly, water vapor permeability, or external impact which damages the connection relationship of internal components.

### SUMMARY OF THE INVENTION

As per the aforementioned issues, a primary objective of the present invention is to provide an identification card apparatus which optimizes the configuration of internal components and improves their connection relationship as per the structural design perspective view, so that the identification card apparatus can extend the transmission range, reduce the overall dimension in thickness and weight, enhance the connection relationship of the internal components, and increase vibration resistance, thereby improving convenience of use.

To achieve the aforementioned objectives, the present invention provides an embodiment in the form of an identification card apparatus, comprising: a main body and an active radio frequency identification module. A first housing member and a second housing member are coupled to each to form the main body. The active radio frequency identification module, disposed inside the main body, further comprising: a battery unit, an integrated circuit board, and a plurality of conductive connecting pieces. The battery unit has at least one coin cell. One end of the conductive connecting piece connects to a side of the coin cell, and the other end of the conductive connecting piece connects to a surface of the integrated circuit board, thereby forming a bending portion for the conductive connecting piece. The coin cell requires at least two conductive connecting pieces to connect with a positive terminal and a negative terminal of the coin cell respectively.

As per the aforementioned objectives, an identification card apparatus according to the present invention can reduce the overall dimensions, in particular, the thickness and weight for increasing portability for ease and convenience of movement by modifying the overall structural design, improving the configuration of components, improving the connection relationship thereof, and developing the composition material. On the other hand, when the product enhances its portability, it also needs to consider how to improve the product reliability and extend the life cycle so as to reduce failure rate. Thus, the design of the conductive connecting piece and the bending portion according to the present invention is capable of minimizing the stress applied to the conductive connecting piece, thereby extending vibration resistance.

In order to further understand the techniques, means and effects the present invention takes for achieving the prescribed objectives, the following detailed description and included drawings are hereby referred, such that, through which, the purposes, features and aspects of the present invention can be thoroughly and concretely appreciated; however, the included drawings are provided solely for reference and illustration, without any intention to be used for limiting the present invention, whose full scope and dimension is described only in the later following claims.

### BRIEF DESCRIPTION OF THE DRAWINGS

FIG. 1 illustrates an exploded diagram of a first embodiment of the identification card apparatus in accordance with certain aspects of the present technique;

FIG. 2 illustrates a block diagram of the first embodiment in accordance with the identification card apparatus according to the present invention;

FIG. 3 illustrates a cross section diagram of the first embodiment associated with the dotted line a-a shown in FIG. 1 according to the present invention;

FIG. 4 illustrates an exploded diagram of a second embodiment of the identification card apparatus in accordance with certain aspects of the present technique;

FIG. 5 illustrates a top view diagram of the second embodiment of the identification card apparatus according to the present invention;

FIG. 6 illustrates a schematic diagram of a third embodiment of the identification card apparatus in accordance with certain aspects of the present technique; and

FIG. 7 illustrates a schematic diagram of a fourth embodiment of the identification card apparatus in accordance with certain aspects of the present technique;

### DETAILED DESCRIPTION OF THE PREFERRED EMBODIMENTS

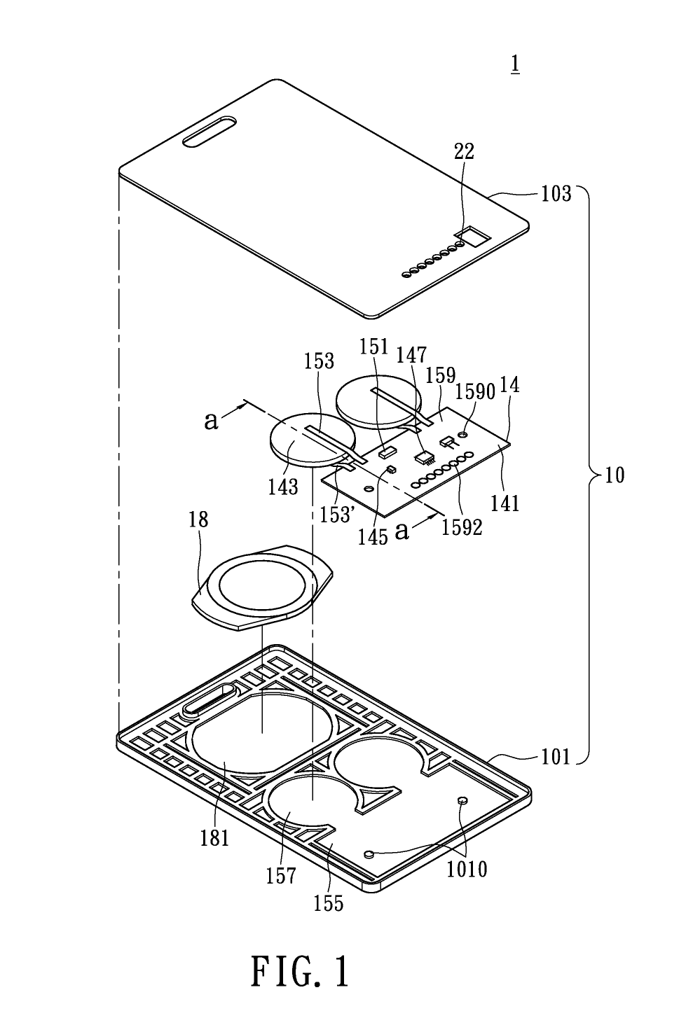

First please refer to FIG. 1, in which an exploded diagram of an embodiment of the identification card apparatus in accordance with certain aspects of the present technique is demonstrated. An identification card 1 includes a main body 10 and an active radio frequency identification module 14. Therein, the main body 10 further includes a first housing member 11 and a second housing member 103, at least one alignment portion 1010, a first accommodating space 155, and a second accommodating space 157 formed on the first housing member 101. The active radio frequency identification module 14 further includes a battery unit 143, an integrated circuit board 141, and a plurality of conductive connecting pieces 153, 153′. The integrated circuit board 141 has a printed circuit board 159, a crystal oscillator 151, a processing unit 147, a modulating unit 145, at least one alignment through hole 1590, and a plurality of terminals 1592 disposed on the printed circuit board 159.

A plurality of through holes 22 is formed on the second housing member. The plurality of the terminals 1592 on the printed circuit board 159 corresponds to the plurality of through holes 22 respectively, so that the external devices can connect to the active radio frequency identification module 14 by means of the terminals 1592 and through holes 22 so as to change the built-in codes or data of the active radio frequency identification module 14. As the first housing member 101 and the second housing member 103 are coupled to each other, a gap between them is sealed to from a seamless main body through the use of ultrasound technology, thereby preventing short circuit problems caused by water vapor permeability due to improper usage. Each alignment portion 1010 of the first housing member 101 is convexly disposed on the first accommodating space 155 with respect to the position of each alignment through hole 1590 of the printed circuit board 159, so that the printed circuit board 159 can be aligned accurately and assembled inside the first accommodating space 155.

The battery unit 143 and the integrated circuit board 141 of the active radio frequency identification module 14 are disposed in the main body 10. The first accommodating space 155 of the first housing member 101 is capable of receiving the integrated circuit board 141, and the second accommodating space 157 of the first housing member 101 is capable of receiving the battery unit 143. Wherein, an end of each of the plurality of conductive connecting pieces 153 electrically connected to the battery unit 143 for electrical power, and the other end of each of the plurality of conductive connecting pieces 153 coupled to a surface of the integrated circuit board 141, such that the battery unit 143 and the integrated circuit board 141 of the active radio frequency identification module 14 are in connection with the plurality of conductive connecting pieces 153 for conduction. The main body 10 and the active radio frequency identification module 14 are composed of anti-vibration material for enhancing vibration resistance and reducing deformation possibility.

In the embodiment, a passive radio frequency identification module 18 is further included. As such, a third accommodating space 181 is correspondingly designed in an appropriate location in the first housing member 101, such that the third accommodating space 181 is capable of receiving the active radio frequency identification module 18. As per the present embodiment, the first accommodating space 155, the second accommodating space 157, and the third accommodating space 181 are concavely disposed in the first housing member 101, and consequently, the overall thickness of the identification card apparatus 1 can be maintained still.

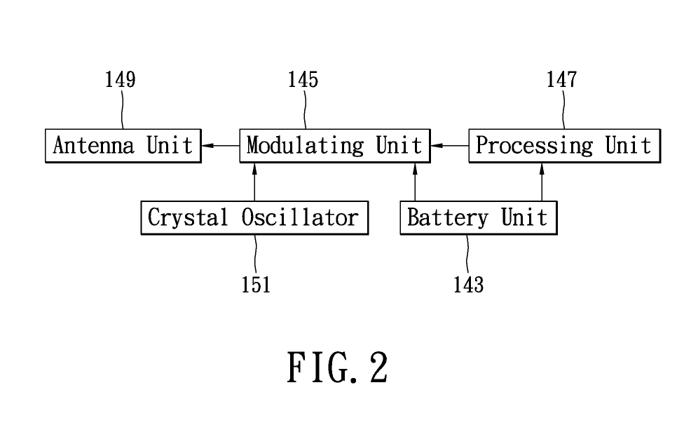

Next please refer to FIG. 2 in conjunction with FIG. 1, in which a block diagram of the first embodiment in accordance with the identification card apparatus according to the present invention is demonstrated. The circuit design of the integrated circuit board 141 includes a plurality of electrical elements for storing, processing, and transmitting identification signals automatically. The processing unit 147 of the integrated circuit board 141 disposed on the printed circuit board 159, and electrically connected with the battery unit 143 for power supply, transmits a radio frequency signal automatically within a predetermined period to the modulating unit 145. The modulating unit 145 disposed on the printed circuit board 159, and electrically connected with the battery unit 143, the processing unit 147, and the crystal oscillator 151. The frequency, the phase, or the amplitude associated with the audio frequency signal outputted from the processing unit 147 is modulated by the modulating unit 145 in conjunction with stabilizing frequency operations of the crystal oscillator so as to generate a modulated radio frequency signal.

The crystal oscillator 151 is disposed on the printed circuit board, for stabilizing the modulated radio frequency signal outputted from the modulating unit 145. The primary structure of the crystal oscillator 151 includes a crystal unit and an oscillating circuit. In general, the characteristics of the crystal oscillator 151 are determined by the structural design and connection relationship of the crystal unit and the structures surrounding the crystal unit. The crystal oscillator 151 which are commercially available generally may have lower vibration resistance because the internal crystal unit is easily to be broke off by applying on external impact. As such, in the embodiment, the vibration resistance is enhanced by strengthening the connection degree of the crystal unit to the surrounding structures associated with the crystal oscillator 151.

Finally, the antenna unit 149 is disposed on the printed circuit board 159, and is electrically connected with the modulating unit 145 for receiving the modulated radio frequency signal. The antenna unit 149 can wirelessly transfer the modulated radio frequency signal within the predetermined period of the processing unit 147, for provoking the corresponding readers to receive the modulated radio frequency signal for identifying and recording information.

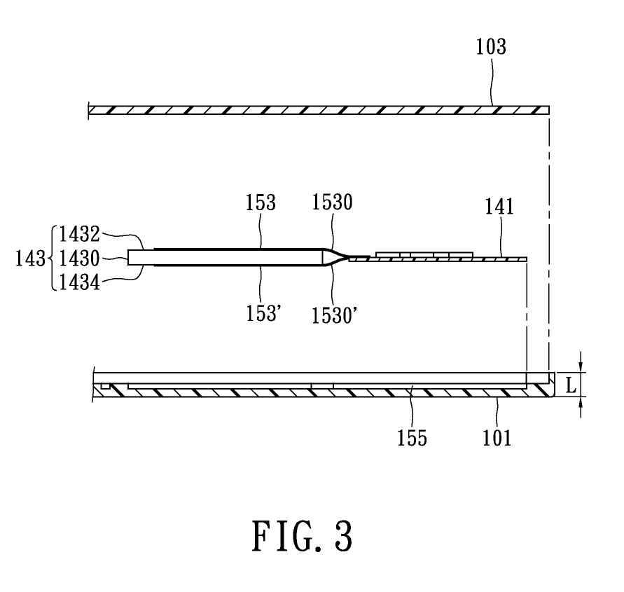

Next please refer to FIG. 3 in conjunction with FIG. 1, in which a cross section diagram of the first embodiment associated with the dotted line a-a shown in FIG. 1 according to the present invention is demonstrated. In the embodiment, the battery unit 143 is composed of two coin cells 1430 (only one coin cell is shown in FIG. 2). The amount of the coin cells of the embodiment is taken as illustration, is not limited thereto. The coin cells 1430 are expanding to be disposed within the second accommodating space 147. Each coin cell 1430 requires at least two conductive connecting pieces 153, 153′ for electrically connecting a positive terminal 1432 and a negative terminal 1434 of the coin cell 1430 correspondingly. An end of the conductive connecting piece 153 connects to a side (positive terminal 1432) of the coin cell 1430 for conducting, and the other end of the conductive connecting piece 153 connects to a part of a surface of the integrated circuit board 141, so that a location of the conductive connecting piece 153 between the battery unit 143 and the integrated circuit board 141 is deformed to form a bending portion 1530; an end of the other conductive connecting piece 153′ connects to a side (negative terminal 1434) of the coin cell 1430, and the other end of the conductive connecting piece 153′ connects to the same surface of the integrated circuit board 141, so that a location of the conductive connecting piece 153′ between the battery unit 143 and the integrated circuit board 141 is deformed to form another bending portion 1530′.

In the embodiment, the simple structure design of the conductive connecting pieces 153, 153′ with low production cost considers a bunch of design factors, such as reducing overall dimensions in thickness L, reducing total weight, and minimizing the stress applied on the fragile positions which are deformed, to achieve the ultimate objectives in the form of increasing the reliability and vibration resistance in accordance with the identification card apparatus 1 according to the present invention. General speaking, the stress is maximized as the bending angle is around 90 degrees, such that the overall structure is easily to be broke off by applying on an external impact. Thus, the angle 40 to 50 degrees of bending portion 1530, 1530′ is taken as a preferred embodiment for illustration, but is not limited thereto.

Moreover, the overall shape of the main body 10 may be an irregular shape, a rectangular shape, or a circular shape. The regular shape is taken as a preferred embodiment for illustration, but is not limited thereto. In the embodiment, the overall thickness L range is reduced to around 2.5 mm to 5.5 mm because the two coin cells 1430 are expanding to be disposed properly. For example, the model Panasonic CR-2025 Coin Cell Lithium Battery is applied in the preferred embodiment for illustration. Consequently, the slim identification card apparatus 1 has characteristics of enhancing portability for ease of movement, identifying actively, and transmitting automatically a radio frequency signal to a corresponding reader within a rather wider specific range. For example, the identification card apparatus 1 according to the embodiment is taken use as a student ID, while a student carried the identification card apparatus 1 enters a classroom or the campus, a specific reader installed in the campus can immediately detect and identify the student ID. As a result, the tracking information of the student can be achieved without requiring the student to go to a specific location which has installed the corresponding reader for scanning the identification card.

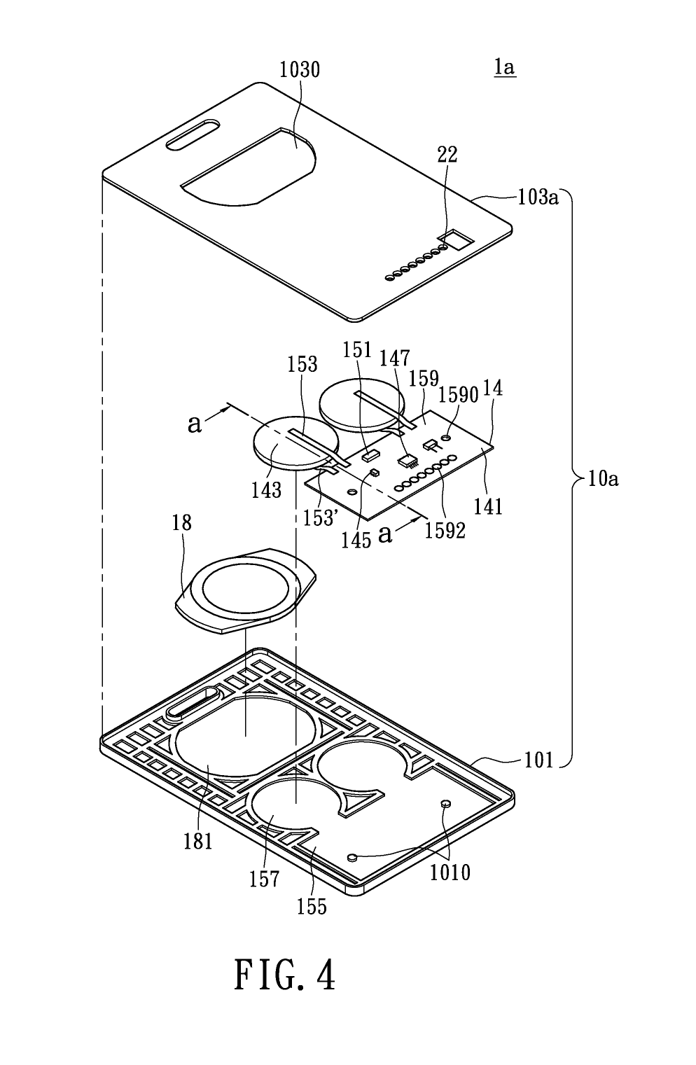

Next please refer to FIG. 4, in which an exploded diagram of a second embodiment of the identification card apparatus in accordance with certain aspects of the present technique is demonstrated. The connection relationship of an identification card apparatus 1a is identical to that of FIG. 1 except of that the structure design of the second housing member 103a is altered by adding an opening 1030. The position of the opening 1030 of the second housing member 103a is designed with respect to the location of the third accommodating space 181 in the first housing member 101. Per user's specific needs, the passive radio frequency identification module 18 can be disposed inside the third accommodating space 181 thru the opening 1030 designed on the second housing member 103a.

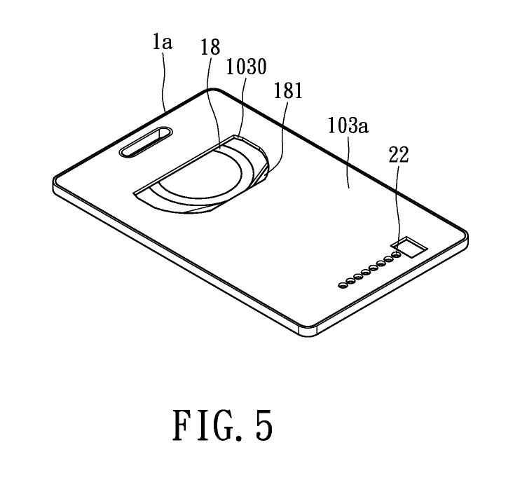

As shown in FIG. 5, the identification card apparatus 1a can not only be used as a general identification card, but also used as an accessing card to certain specific areas which have higher security. For example, while faculties and staffs are required to go thru security checking of a specific area, the built-in passive radio frequency identification module 18 can be provoked to generate a radio frequency signal by closing by a RFID reader for receive an identification signal transmitted from the RFID reader.

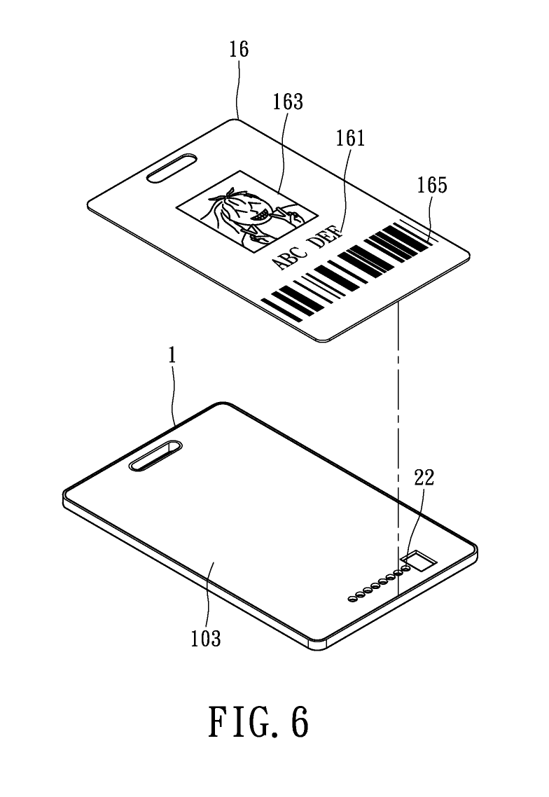

Next please refer to FIG. 6 in conjunction with FIG. 1, in which an exploded diagram of a third embodiment of the identification card apparatus in accordance with certain aspects of the present technique is demonstrated. The connection relationship of the identification card apparatus 1 is identical to that of FIG. 1 except of adding an overlay 16. A side of the overlay 16 has a back adhesive for attaching on the second housing member 103, and the other side of the overlay is printed with a text 161, an image 163, or a barcode 165, etc. Thus, the identification card apparatus 1 can not only apply both the active radio frequency identification module and the passive radio frequency identification module, but also incorporate with the barcode 165 to extend the application field. For example, the card according to the embodiment can be used as a library card, or the like. It is worth mentioning that as the overlay 16 attached on the second housing member 103, the plurality of through holes 22 can also be blocked, thereby preventing water droplets spraying on the second housing member 103 and passing trough the through holes 22 to permeate into the identification card apparatus 1. Similarly, as the overlay 16 attached on the second housing member 103, the opening 1030 can also be blocked.

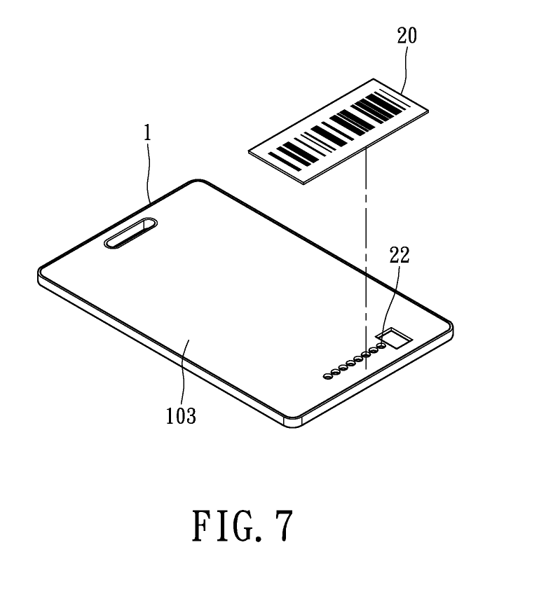

Finally please refer to FIG. 7 in conjunction with FIG. 1, in which an exploded diagram of a fourth embodiment of the identification card apparatus in accordance with certain aspects of the present technique is demonstrated. The embodiment is similar to the third embodiment except of replacing the overlay 16 by a barcode sticker 20 which is easy to produce with low cost. Consequently, The barcode sticker 20 is attached on the second housing member 103 is capable of blocking water droplets passing thru the through holes 22 and protecting the identification card apparatus 1 from water permeability.

In the aspects of the aforementioned embodiments, the technical characteristics of the identification card apparatus according to the present invention are achieved, such as high vibration resistance, high reliability, and high convenience, by applying simple structural design and low manufacturing cost, so that the identification card apparatus is applied widely in life. In conclusion, by utilizing the technical features, the expanded distribution of coin cells, the anti-vibration structural design of the conductive connecting piece, the customized anti-vibration structural design of the crystal oscillator, and the composition material for enhancing vibration resistance in applications, the identification card apparatus can achieve the following specifications: low production cost, simple structure, high vibration resistance, and ultra-slim and thin design.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. An identification card apparatus comprising:
a main body having a first housing member and a second housing member, wherein the first housing member and the second housing member are coupled to each other to form the main body; and
an active radio frequency identification module being disposed inside the main body, further including:
a battery unit for supplying electric power;
an integrated circuit board for storing, transmitting and processing information; and
a plurality of conductive connecting pieces being connected between the battery unit and the integrated circuit board correspondingly, wherein each of the conductive connecting pieces has a bending portion on a location thereof between the battery unit and the integrated circuit board.

2. The identification card apparatus according to claim 1, wherein the first housing member defines a first accommodating space and a second accommodating space formed thereon for accommodating the integrated circuit board and the battery unit, respectively.

3. The identification card apparatus according to claim 2, wherein the integrated circuit board, further includes:
a printed circuit board;
a crystal oscillator coupled to the printed circuit board;
a processing unit coupled to the printed circuit board, and electrically connected to the battery unit for storing, processing information and transmitting a radio frequency signal automatically within each predetermined period;
a modulating unit coupled to the printed circuit board, and electrically connected with the battery unit, the processing unit and the crystal oscillator for receiving the audio frequency signal outputted from the processing unit, modulating the frequency, the phase, or the amplitude of the audio frequency signal, and generating a modulated radio frequency signal in accordance with stabilizing frequency operations of the crystal oscillator; and
an antenna unit coupled to the printed circuit board, and electrically connected with the modulating unit for receiving the modulated radio frequency signal and wireless transferring the modulated radio frequency signal within the predetermined period.

4. The identification card apparatus according to claim 2, wherein the first housing member defines a third accommodating space formed thereon.

5. The identification card apparatus according to claim 4, further comprising a passive radio frequency identification module accommodated in the third accommodating space.

6. The identification card apparatus according to claim 1, further comprising an overlay, wherein one side of the overlay has a back adhesive for attaching on a surface of the second housing member, and the other side of the overlay is printed with a text, an image, or a barcode.

7. The identification card apparatus according to claim 3, wherein the first housing member has at least one alignment portion disposed thereon and the printed circuit board has at least one alignment through hole aligned with the alignment portion of the first housing member to position.

8. The identification card apparatus according to claim 1, wherein the integrated circuit board has a plurality of terminals, and the second housing member has a plurality of through holes aligned with the terminals of the integrated circuit board, respectively.

9. The identification card apparatus according to claim 1, wherein the battery unit includes at least one coin cell having two sides electrically connected to parts of the integrated circuit board through two of the conductive connecting pieces, respectively.

10. The identification card apparatus according to claim 9, wherein the main body is of an irregular shape, a rectangular shape, or a circular shape, and the main body has a thickness in the range of 2.5 mm to 5.5 mm.
